(19) United States
(12) Patent Application Publication
(10) Pub. No.: US 2014/0310165 A1
(43) Pub. Date: Oct. 16, 2014

(54) TWO-WAY VENDING

(71) Applicant: Tricopian, LLC, Del Mar, CA (US)

(72) Inventor: Chi W. Yau, Escondido, CA (US)

(73) Assignee: Tricopian, LLC, Del Mar, CA (US)

(21) Appl. No.: 14/358,027

(22) PCT Filed: Nov. 15, 2012
(86) PCT No.: PCT/US2012/065326

§ 371 Date: May 13, 2014

Related U.S. Application Data
(60) Provisional application No. 61/659,674, filed on Jun. 14, 2012.
(60) Provisional application No. 61/560,672, filed on Nov. 16, 2011.

(51) Int. Cl. G07F 11/00; G07F 7/06; G06Q 20/10

(52) U.S. Cl. CPC G07F 11/002; G06Q 40/02; G06Q 20/10; G07F 7/06
USPC 705/39; 700/236

(57) ABSTRACT

Two-way vending can be performed by a two-way vending machine for vending rechargeable batteries. A two-way vending machine can include different modules to perform different functionalities. A two-way vending machine can include a communications module, a payment module, a dispensing module, and a receiving module. A communications module can communicate information to and receive inputs from a user. A payment module can transact payment with the user. A dispensing module can dispense one or more rechargeable batteries or other requested products to a user. A receiving module can receive one or more rechargeable batteries from a user.

### CROSS-REFERENCE TO RELATED APPLICATIONS

This application claims priority to U.S. Provisional Application 61/659,674 filed Jun. 14, 2012, and U.S. Provisional Application 61/560,672, filed Nov. 16, 2011, which are herein incorporated by reference in their entirety.

### BACKGROUND OF THE INVENTION

1. Field of the Invention

This relates to the field of vending, and particularly to the field of two-way vending of reusable or recyclable products, such as, for example, rechargeable batteries.

2. Description of the Related Art

Batteries power a variety of devices. As more devices become battery powered, consumer demand for batteries increases. This results in the manufacturing and disposal of ever greater numbers of batteries, which can include precious metals or other toxic materials such as, mercury, cadmium, or lead. Some people have begun using rechargeable batteries to save money and to minimize battery waste. However, rechargeable batteries require careful recharging, optimally achieved with expensive chargers, and are not as convenient as disposable batteries.

### SUMMARY OF THE INVENTION

Some embodiments relate to a two-way battery vending machine. A two-way battery vending machine can include, for example, a communications module that communicates information to a user and receives inputs from a user including input indicative of the user identity, a dispenser that dispenses a selected battery, a receiver that receives a battery, an identifier configured to identify a battery by reference to an identification characteristic, a processor that controls the vending machine, and memory including stored instructions for operation of the vending machine.

In some embodiments the two-way battery vending machine further includes a receptacle to store a received battery, a storage area for the battery before it is dispensed, or a network communications module that communicates vending machine information across a network. In some embodiments, associating the battery with an account as performed by the two-way vending machine can further include associating the identification characteristic with a user account.

In some embodiments of the two-way battery vending machine the identifier can be a scale and the unique identification characteristic can be a weight, the identifier can be a scanner and the identification characteristic can be a computer readable code, or the identifier can be a camera and the identification characteristic can be a visible feature. In some embodiments of the two-way battery vending machine the identification characteristic can be a pattern, the identification characteristic can be one or more colors, the identification characteristic can be an ultraviolet marking, the identification characteristic can be a fluorescent marking, the identification characteristic can be an infra-red marking, or the identification characteristic can be a radio emitter. In some embodiments of the two-way battery vending machine, the network communication module can communicate with a server across a network.

Some embodiments relate to a method of using a two-way battery vending machine. The two-way battery vending machine can include the features discussed above. The method can include, for example, dispensing a requested battery, which dispensing can include, receiving a request for dispensing of a battery via the communications module, processing the request with the processor, identifying the requested battery by the identification characteristic, associating the requested battery with an account, and dispensing the requested battery. The method of using a vending machine can further include receiving a battery, which can include, for example, identifying the received battery, associating the received battery with an account, and crediting the account when the received battery has specified characteristics.

In some embodiments of the method of using the vending machine, the requested battery can be dispensed in a battery container that can, in some embodiments, include an identification feature. In some embodiments of the method of using the vending machine, identifying the requested battery can include scanning a computer readable code, or receiving a data containing radio signal. In some embodiments of the method of using the vending machine, associating the requested battery with an account can include associating the identification characteristic with an electronic payment account that can be, for example, a credit account, a bank account, or a user account identifier. In some embodiments of the method of using the vending machine, the user account identifier can be, for example, an email account, an account number, or a user name.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 depicts a front view of one embodiment of a battery case.

FIG. 2 depicts a front view of one embodiment of a two-way vending machine.

FIG. 3 is a flow chart illustrating one embodiment of a method of operating a two-way vending machine to distribute one or several rechargeable batteries.

FIG. 4 is a flow chart illustrating one embodiment of a method of operating a two-way vending machine to receive one or several deposited rechargeable batteries.

FIG. 5 is a flow chart illustrating a method of operating a two-way rechargeable battery vending machine to determine if one or several received items are returnable, rechargeable batteries.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

As used herein, the term battery may be refer to any device or electrical unit capable of storing electrical energy. For example, the term battery may refer to standard consumer batteries denoted as AAA, AA, C, D, 9V, CR-123, etc. The term battery may refer to a battery power unit configured to provide backup power to a mobile device such as a tablet computer, GPS unit, smart phone, mp3 player, or other mobile electronic device. Battery may refer to energy storage devices having a variety of chemical compositions.

Some embodiments disclosed herein relate to machines configured for two-way vending of rechargeable batteries. In some embodiments, a two-way rechargeable battery vending machine can comprise a variety of features in a variety of combinations. In some embodiments, these features can be configured to perform designated functions. Some embodiments include a vending machine capable of performing more or fewer functions than those described herein. In some embodiments, features of a two-way rechargeable battery vending machine can include, for example, an interactive communications module, a dispenser, an identification module, a processor, memory, a network communications module, and/or any other desired features. In some embodiments of a two-way rechargeable battery vending machine, the two-way rechargeable battery vending machine can communicate with a central control and monitoring station. In some embodiments, a two-way rechargeable battery vending machine, the two-way rechargeable battery vending machine can communicate with a central control and monitoring station over a network, such as, for example, the internet. In some embodiments, the two-way rechargeable battery vending machine can communicate information such as, for example, inventory status, functionality status of the two-way rechargeable battery vending machine, service requests, user account updates, and/or any other desired information to the central control and monitoring station.

Various types and configurations of batteries, battery packs, charging units, and other power providing devices are disclosed. As used herein, the term battery may refer to any of the types of power providing devices disclosed, including standard batteries, battery packs, charging units, etc.

Some embodiments disclosed herein relate to methods of two-way vending of rechargeable batteries. Some embodiments can include a variety steps performed in a variety of orders. Some embodiments can include more or fewer steps than those specifically outlined herein. In some embodiments, the steps outlined herein can be supplemented by additional steps. In some embodiments, methods of two-way vending of rechargeable batteries can include, for example, receiving a user request, dispensing requested rechargeable batteries, receiving batteries, identifying received batteries, associating the received batteries with an account, storing the received batteries, and/or any other desired steps.

A two-way rechargeable battery vending machine can comprise a variety of shapes, sizes and configurations. In some embodiments, a two-way rechargeable battery vending machine can be sized for floor mounting, for wall mounting, for table/countertop mounting, or for any other desired mounting configuration. In some embodiments, a vending machine can be shaped so as to facilitate machine identification, and/or configured to advertise the services provided by the vending machine. In some embodiments, a two-way rechargeable battery vending machine can be shaped to resemble a battery. In some embodiments, the two-way rechargeable battery vending machine can be shaped and colored to resemble the batteries vended by the machine.

A two-way rechargeable battery vending machine can be configured to vend a variety of products. In some embodiments, a two-way rechargeable battery vending machine can be configured to vend rechargeable batteries. In some embodiments, a two-way rechargeable battery vending machine can be configured to vend certain sizes of rechargeable batteries, such as, for example, AAA, AA, C, D, 9-volt, or any other battery size. In some embodiments, a two-way rechargeable battery vending machine can be configured for vending of non-battery products, such as, for example, a battery size adapter. In some embodiments, a vending machine can be configured to vend, for example, an AA to D-size battery adapter case, an AA to C-size battery adapter case, an AAA to D-size battery adapter case, an AAA to C-size battery adapter case, or any other desired battery adapter case, or other accessories.

In some embodiments, a two-way rechargeable battery vending machine is configured to vend a battery power unit. A battery power unit is a rechargeable unit having one or more electrochemical cells contained within an enclosure and having a charge port and a discharge port. The battery power unit may have one of a variety of form factors. For example, the battery power unit may be cylindrical, circular, square, rectangular prism, or any other desirable form factor.

The battery power unit may comprise a plurality of electrochemical cells, or battery cells, or may have a single battery cell. Where the battery power unit comprises a plurality of battery cells, the battery cells may be one of many battery chemistries suitable for rechargeable batteries. For example, the battery cells may be Li-ion, NiMH, NiCd, fuel-cell based, or lead acid. The battery power unit may comprise one or more standard battery cells, e.g., AAA, AA, C, D, or 9V, arranged within an enclosure and wired together. The battery cells may be wired in series or parallel, connected to a single discharge port.

As used herein, the term terminal or battery terminal may refer also to the discharge port or the charge port of the battery power unit. The discharge port may be one of many varieties, such as those commonly used on electrical devices having an internal or integral battery or power source. Specifically, the discharge port maybe configured to have a port compliant with the universal serial bus (USB) standard. In some embodiments, the discharge port may be a 3.5 mm jack, a standard 120V plug, microUSB, or other suitable discharge port. The charge port may be one of many varieties, including those described herein with reference to the discharge port. The charge port is wired to the battery cell or cells within the battery power unit such that a power source supplied to the charge port will charge all the battery cells within the battery power unit. In some embodiments, the charge and discharge ports may be co-located on a single end of the battery power unit for convenience of access and use. In some embodiments, the functions of the charge and discharge ports can be combined into a single port. In some embodiments, the charge and discharge ports can be separate.

The battery power unit may also comprise internal electronics configured to transform, step-up, step-down, modulate, rectify, regulate, or otherwise adapt the output of the battery cell or cells to be compatible with a specific device to be charged. The internal circuitry may be connected to one or both of the charge and discharge ports. The internal circuitry may be connected to the discharge port and provide communication functionality such that, upon connecting a cord or plug to the discharge port, the internal circuitry identifies the device or type of device, and adjusts the output power or signal accordingly. The internal electrical circuitry is also configured to adapt a power source or signal applied to the charge port such that the applied power source or signal is transformed or changed to be compatible with and capable of charging or recharging the battery cell or cells within the battery power unit enclosure. Either the charging port or discharging port can be used by an external charging system to ascertain the type or model or category of the battery power unit for the purpose of product identification and/or application of appropriate charging regime, program, algorithm

In one exemplary embodiment, the battery power unit may enclose one or a plurality of Li-ion 18650-type batteries. The batteries are connected to a discharge port which comprises a USB port. The battery power unit has internal circuitry which transforms the voltage to a voltage used in a handheld mobile device, such as a cellular telephone or a tablet computer. In this embodiment, the battery power unit acts as a backup power supply for the handheld mobile device, providing a source from which to charge the internal battery of the mobile handheld device.

In some embodiments, a two-way rechargeable battery vending machine may vend a rechargeable battery pack. In some embodiments the rechargeable battery pack may be a mobile device charging unit. The mobile device charging unit may be of many types and support charging of many devices. For example, the mobile device charging unit may be rechargeable using a DC, AC, or other power source, such as solar cells. The mobile device charging unit may provide one or more charging ports, including a USB charging port, a micro USB charging port, mobile phone charging ports, or any other charging port. In some embodiments the battery pack is a battery power unit that can be connected to various devices and provides charging capability for various mobile devices such as mobile phones, tablet computers, laptop computers, mp3 players, GPS units, portable gaming devices, and others.

In some embodiments of a two-way rechargeable battery vending machine, a battery can be individually vended. In some embodiments of a two-way rechargeable battery vending machine, a battery can be vended with other batteries. Thus, in some embodiments, a user may be able to specify an exact number of batteries for purchase, and in other embodiments, a user may specify the number of packages of batteries for purchase.

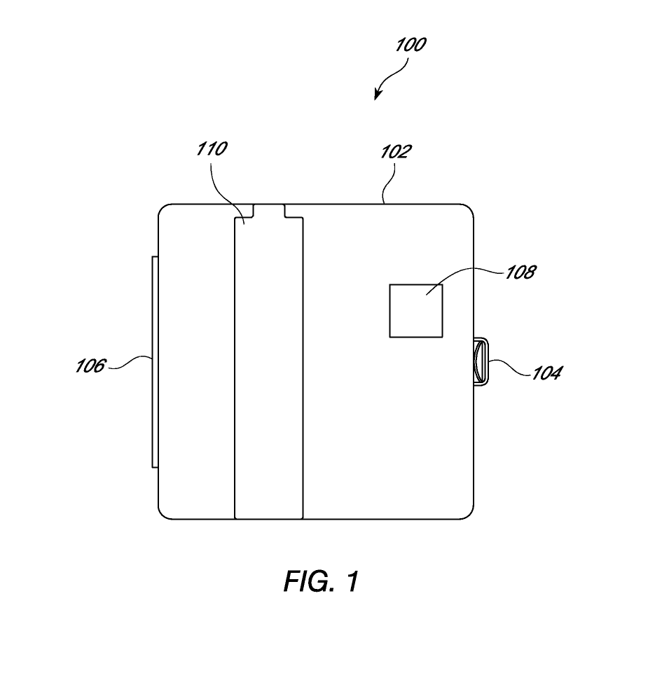

In some embodiments, one or several batteries can be vended as individual units, or can be vended packaged into groups of multiple batteries. In one embodiment, and as depicted in FIG. 1, the batteries can be vended in a battery package 100. In some embodiments, a battery package can be reusable or disposable. In some embodiments, the battery package 100 can hold one or several batteries 110 of a variety sizes, shapes, and/or types. In some embodiments, a battery package 100 can be configured to hold, for example, one battery, two batteries, three batteries, four batteries, five batteries, eight batteries, ten batteries, twelve batteries, or any other desired number of batteries. In some embodiments, the battery package 100 can be configured to hold one or more battery power units.

In some embodiments, and as depicted in FIG. 1, a battery package 100 can comprise a reusable battery case 102. In some embodiments, a case 102 can comprise, for example, any desired type of container or packaging such as, for example, an envelope, a bag, a box, shrink wrap, a blister pack, or any other type of container or packaging. A battery case can include a latch 104 and a hinge 106. In some embodiments, a battery case can include internal features configured, for example, to secure one or several batteries within the battery case.

A battery case 102 can further comprise an identification feature 108. In some embodiments, an identification feature 108 can be a unique identification feature or a non-unique identification feature. In some embodiments, using a system where a plurality of battery cases 102 are used by multiple users, identification feature 108 may be configured to identify a specific battery case 102. In some embodiments, identification feature 108 may be common to all battery cases 102, and serve to identify a battery case 102 as a reusable battery case 102. In some embodiments, an identification feature 108 can be affixed, adhered, or attached to the battery case 102. In some embodiments, the identification feature 108 can be integrated into the battery case 102. An identification feature 108 can include, for example, a computer readable code, an electronic tag, a color or text pattern, or any other identifying feature.

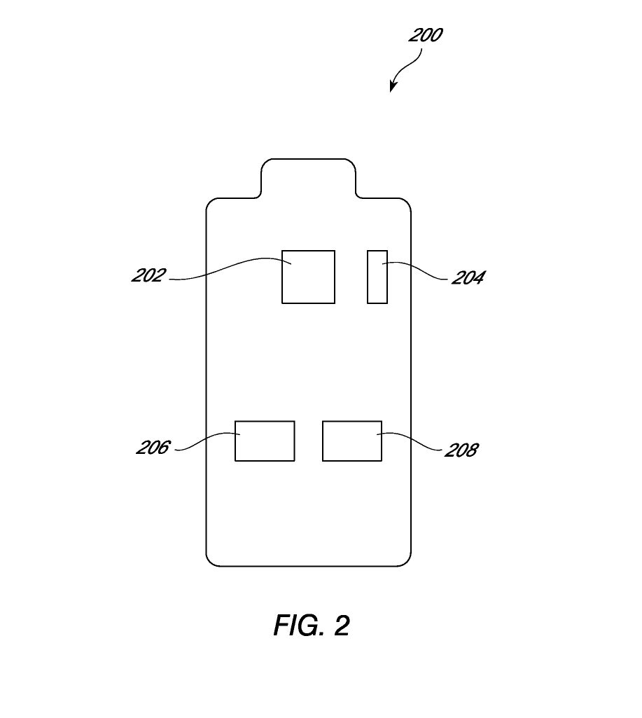

A two-way rechargeable battery vending machine can comprise a variety of functionalities to facilitate vending. FIG. 2 depicts one embodiment of a two-way rechargeable battery vending machine 200 which resembles a battery. As further depicted in FIG. 2, a two-way rechargeable battery vending machine can comprise a communications module 202, a payment module 204, a dispensing module 206, and a receiving module 208.

In some embodiments, a communications module 202 can be configured to communicate with a user of the two-way rechargeable battery vending machine 200. Specifically, in some embodiments of the two-way rechargeable battery vending machine 200, the communications module 202 can be configured to communicate information to the user and to receive inputs from the user. In some embodiments, a communications module can include, for example, a display screen, a speaker, or any other feature or feature combination capable of communicating information to a user of the two-way rechargeable battery vending machine 200. In some embodiments, a communications module 202 can comprise one or several input features such as, for example, a key pad, a touch screen, a track pad, a microphone, voice recognition hardware and software, or any other feature or features capable of receiving a user input.

In one embodiment of a two-way rechargeable battery vending machine 200, a communications module 202 can comprise a touch screen configured to communicate information to a two-way rechargeable battery vending machine 200 user and to receive inputs from the user.

In some embodiments, the communications module 202 of a two-way rechargeable battery vending machine 200 can communicate information to a user including, for example, the availability and costs of one or several batteries, one or more battery power units, the availability or cost of other vended products, such as, for example, a battery container, a battery adapter, or any other product, user account information, such as, for example, number of batteries purchased during a specified time frame, the number of batteries purchased and not returned, the number batteries returned during a specified time frame, and/or membership information. In some embodiments, some or all of the communicated information can relate to the user desired transaction with the vending machine. Thus, in some embodiments, the communications module 202 can request a user to indicate a desired transaction such as, for example, purchase of one or more charged batteries, purchase of a vended item, or return of one or more batteries.

In some embodiments of a two-way rechargeable battery vending machine 200, the selection of a desired transaction type can be communicated to a controller. The controller can comprise, for example, a processor and memory with stored instructions. In some embodiments, the controller can have a communications link with some of the features of the two-way rechargeable battery vending machine 200 to receive inputs from these features. In some embodiments, the controller can further provide electronic signals to the features of the two-way rechargeable battery vending machine 200 that control or direct the operation of these features. In some embodiments, the controller can receive and process the user input, and in response to the input, direct the communication of information relating to the requested transaction to the user. This information can include, for example, pricing information, product availability, related products, or any other desired information. This information can allow the user to provide further inputs to the two-way rechargeable battery vending machine 200 to select the user desired transaction. Advantageously, the use of a communications module allows the two-way rechargeable battery vending machine 200 to communicate information relating to products to the user, and the user to input information relating to the desired transaction into the two-way rechargeable battery vending machine 200.

A two-way rechargeable battery vending machine 200 can include a payment module 204. A payment module 204 can include any feature or features configured to receive payment from a user. In some embodiments, a payment module 204 can be configured to receive cash payment or to receive electronic payment. In some embodiments, a payment module 204 can be a scanner configured for use with, for example, a credit card, or a debit card, a smart phone, a near field communication device, or a cash input device. In some embodiments, a user may have a unique identifier, such as, for example, a card, which encodes identification information specific to a user. The unique identifier, such as the card, is associated with an account of the user. In some embodiments, as the unique identifier card is used in the two-way rechargeable battery vending machine 200, a user's account or identification information is accessed, and a vending transaction occurs based on a balance of money or credit in user's account. The users account information, which is associated with and accessible by the unique identifier, such as the card, is updated as batteries are vended.

In some embodiments, payment module 204 may comprise a near field communication (NFC) device. A customer having a NFC enabled payment device may bring the device within vicinity of the NFC device, and transact a payment. In some embodiments, the payment module may comprise a QR code, high capacity color barcode (HCCB), or other two-dimensional code. A customer may scan the QR code, HCCB, or other two-dimensional code with a smart phone or other device capable of reading two-way barcodes. The QR code, HCCB, or two-dimensional code may point the customer to a website, application, or other destination where the customer may subscribe to the battery vending service, provide payment, or transact other business related to the two-way rechargeable battery vending machine. A person of skill in the art will recognize that the present disclosure is not limited to any specific feature for receiving payment, but that it broadly encompasses all features capable of receiving payment.

In some embodiments, a two-way rechargeable battery vending machine 200 can comprise a dispensing module 206. A dispensing module 206 can be configured to remove one or more batteries from inventory storage, identify the one or more batteries, if necessary, and dispense the one or more batteries to the user.

A dispensing module can include a variety of features and functionalities. In some embodiments, a dispensing module can include, for example, inventory storage configured to store one or more batteries, dispensing features configured to deliver one or more batteries from the inventory storage to a user, and any other desired features.

Some embodiments of a dispensing module 206 can include an identifier. An identifier can be configured, for example, to identify a product before dispensing. In some embodiments, an identifier can include, for example, a scanner, a camera, a receiver, or any other component capable sensing an identifying characteristic of one or more batteries. In some embodiments, a scanner can be, for example, configured to scan a computer readable code such as, for example, a bar code, a QR code, and/or other one or two dimensional barcodes. The bar code may be one of conventionally known one or two dimensional codes. The barcode may use Pharma code protocol as promulgated in Pharma Code Specifications from RC Electronica, located at www.reclectronica.com. In some embodiments, a camera can be configured, for example, create an image of an identifiable aspect of a vended item for use in image analysis. In some embodiments, a receiver can be configured, for example, to receive an emitted signal identifying the vended item, such as, for example, a radio signal from an RFID tag.

In some embodiments, the identifier of dispensing module 206 may be configured to identify a product before dispensing by detecting and identifying a battery based on electrical characteristics. For example, the identifier of dispensing module 206 may comprise a battery meter configured to sense battery voltage and resistance based on measurements between a terminal of the battery and the battery can.

In non-rechargeable, disposable, alkaline batteries, the positive terminal of the battery is usually in direct electrical contact with the battery can, and the can is electrically isolated from the negative terminal, or, in other words, is separated from the negative terminal by the cell or cells within the battery. Thus, a resistance measurement between the can and the positive terminal of a healthy battery will generally be zero or nearly zero. Similarly, resistance taken between the can and the negative terminal of a healthy battery will generally yield a high resistance, for example, greater than about 90 mΩ.

In rechargeable, reusable batteries, the negative terminal of the battery is generally in direct electrical contact with the can and the positive terminal is electrically isolated from the can, or in other words, is separated from the can by the cell or cells within the battery. In a cylindrical battery, the can is the cylindrical portion, but may also wrap at least partially around the end of the battery. Thus, a resistance measurement taken between the can and the positive terminal of a healthy rechargeable battery will be low, for example, less than about 90 mΩ. Similarly, a resistance measurement taken between the can and the negative terminal will yield high resistance, for example, greater than about 90 mΩ. As such, a battery can be identified as either a disposable battery or a rechargeable battery based on the terminal-can voltage measurement. In some embodiments, the battery meter may sense voltage between a battery terminal and the battery can or resistance between a battery terminal and the battery can, or both and identify the battery based on the battery's electrical characteristics. If the battery is identified as a rechargeable battery, or a battery proprietary to the two-way vending machine system, the battery may pass the identification process. If the battery fails the identification process, the battery may not be vended, and another battery which passes the identification test may be vended instead.

In some embodiments, the battery meter may measure the voltage or resistance from a terminal to the battery can, or from one terminal to the other. The battery meter may determine, based on these measurements, a healthy battery is being vended. If a terminal-to-terminal or terminal-to-can voltage is within a prescribed range, then a battery may be identified as healthy, and may be vended to a consumer or customer. If a terminal-to-terminal or terminal-to-can resistance is within a prescribed range, then a battery maybe identified as healthy, and may subsequently be vended to a consumer or customer. In some embodiments, a battery may be vended only when the voltage characteristics, resistance characteristics, or both are within a prescribed range.

In some embodiments, the charge state of the battery can be indicated through the application of one or more tabs to the battery. The tab may comprise an adhesive configured to adhere to a terminal of a battery, and may be sized or shaped to correspond to the size and shape of a battery terminal. The tab may comprise a conducting or non-conducting, and may comprise one or more indication which communicates information about the state of charge of the battery. For example, the tab may indicate when a battery is “full,” “fresh,” or “fully charged.”

In some embodiments, one or more batteries may vended disposed within an enclosure. The enclosure may be a wrapper, a case, or a packet. The enclosure may comprise an indication of the state of charge of the battery, such as “full,” “fresh,” or other indication the battery is fully charged. In some embodiments, the presence of the wrapper may be the indication that the vended batteries are in a fully charged state. The enclosure may provide protection to the batteries against incidental discharge, damage, vandalism. The enclosure may indicate that the batteries have not been altered, modified, or tampered with.

In some embodiments, data indicative of the identity of the vended item can be collected by the controller of the two-way rechargeable battery vending machine 200, and can, in some embodiments, be associated with a user, an account, and/or a user account.

As depicted in FIG. 2, a two-way rechargeable battery vending machine 200 can comprise a receiving module 208. In some embodiments, a receiving module can be configured to receive one or several batteries, to identify one or more received batteries, to communicate the identification for the one or more batteries to a controller, and/or to place the one or more batteries in a storage receptacle for received batteries.

A receiving module 208 can include a variety of features and functionalities. In some embodiments, for example, a receiving module 208 can comprise a receiving receptacle configured to receive batteries, a receiving identifier configured to identify one or more received batteries, a storage receptacle for storing received batteries, and features configured to transport the one or more received batteries from the receiving receptacle to the storage receptacle. In some embodiments, a receiving module can include each or some of these features. In some embodiments, a receiving module 20 can include additional features. In some embodiments, one or several of these features can be integrated into a single location.

In some embodiments, a receiving identifier can include features configured to identify the received batteries. In some embodiments, this identification can comprises uniquely identifying each received battery. In some embodiments, this identification can comprise identification of a class or category of each returned battery. In some embodiments, this identification can comprise identification of some dimension associated with a battery.

In one embodiment, for example, each battery can comprise a unique identification feature. This feature can include, for example, a computer readable unique identification feature, a receivable unique identification feature, a recognizable unique identification feature, or any other type of unique identification feature. In some embodiments, each battery can comprise a non-unique identification feature, indicating, for example, a class or category of each battery. In some embodiments, each battery can include an identifiable feature or be associated with an identifiable dimension, such as, for example, a weight. In some embodiments in which batteries are distributed in a case, and as discussed above, each case can include a unique or a non-unique identification feature.

In some embodiments, a battery or a battery case can include, for example, computer readable code such as, for example, a bar code or a QR code. In some embodiments, a battery or a battery case can include a non-unique identification feature such as, for example, a logo, color scheme, or any other identifiable features. In some embodiments, the identification feature can be configured to emit an identifying signal. In some embodiments, a computer readable code or other identification feature can be printed on, adhered to, affixed to, or embedded in a battery or a battery case. In some embodiments in which the identification feature is printed, the identification feature can be printed with fluorescent ink, ultraviolet ink, infrared ink, normal ink, or any other type of ink.

In some embodiments, a battery can be received by the receiving module 208 after the battery is placed within a disposable container. In some embodiments, this disposable container can include, for example, an envelope. The disposable container can include a unique identification feature, such as, for example, a computer readable code, which can be associated with a user account via the receiving identifier of the receiving module 208. In some embodiments, the unique identification feature can be used to track the disposable container and the contents of the disposable container. This tracking is particularly beneficial in that it can enable the operator of the vending machine to verify the returnability and condition of the contents of the disposable container and allow association of the returned contents with a specific user.

In some embodiments, a receiving identifier may use a variety of techniques to identify the received battery. In some embodiments, a deposited item is weighed to determine if the weight of the deposited item matches the expected weight of the item. In some embodiments, the receiving identifier may scan a received battery to determine if the battery is of a specific type such as, for example, a rechargeable battery, a vended battery, a specific size of battery, a battery power unit, or any other desired type. In some embodiments in which a battery is returned in a battery case, a unique identification feature on the battery case is scanned, and the case is associated with a user account. In some embodiments, a receiving identifier may preliminarily identify the received battery. In some embodiments, a preliminary identification of a received battery can be finalized by reference to an additional identification feature identifying the battery.

In some embodiments, the receiving identifier maybe configured to read a rotation-variant, rotation-invariant, or rotation agnostic identification mark. The term rotation-variant used in reference to identification marks or features on a battery means a feature or mark or symbol that may appear different depending on the orientation of the battery about an axis. For example, a logo, a word, or other similar identification mark may appear different when viewed from different perspectives, and therefore is rotation-variant. The term rotation-invariant used in reference to identification marks or features on a battery means a feature, mark, or symbol that appears the same regardless of the orientation of a battery about an axis or regardless of the point of view of a sensing or identification unit. For example, a stripe, line, barcode, or symbol which encompasses the entire circumference or outer perimeter of a cylindrical battery and is uniform over the circumference or outer perimeter is rotation-invariant. For example, a barcode may comprise a bar or set of bars which each completely encircle or circumscribe the battery, and appear the same regardless of the orientation of the battery when rotated about an axis. However, a barcode may also be rotation-variant, depending on the orientation of its bars, or if it does not encompass the entire circumference or outer perimeter of the battery. The term rotation-agnostic used in reference to identification marks or features on a battery means a feature or mark that may appear different depending on the orientation of the battery about an axis, but can nonetheless be used to identify the battery, regardless of the battery orientation. For example, a mark, symbol, or barcode on an end of a cylindrical battery may appear different as a battery rotates about an axis, but can still be used to positively identify a battery regardless of orientation. A rotation agnostic mark may be, for example, a radial bar code, a QR code, a high capacity color barcode, an Aztec code, or other one or two-dimensional barcode.

In some embodiments, the owner/operator of a proprietary battery vending machine or battery exchange machine may wish to receive or vend only proprietary batteries or rechargeable batteries the owner/operator has previously provided. In order to ensure that only previously provided batteries are accepted or exchanged in the battery machine, the machine may have some system for identifying batteries inserted into receiving module 206 as rechargeable or proprietary.

In some embodiments, the receiving identifier may use some electrical characteristics of a battery to identify whether a battery is rechargeable or acceptable for return. The two-way battery vending machine may identify batteries as being rechargeable or as being proprietary batteries of the owner and operator of the two-way battery vending machine. In some embodiments, the two-way battery vending machine may comprise an internal battery charging system. If an incompatible battery, for example, a regular alkaline battery, is received into a two-way battery vending machine, the incompatible battery may interfere with proper operation of the machine, if the machine comprises an internal charging system an incompatible battery may adversely affect the charging system of the machine, or may otherwise cause difficulty.

Receiving module 208 may comprise a battery testing meter capable of determining whether a battery is rechargeable using the electrical characteristics of a battery. For example, as described elsewhere herein, batteries may be identified or typed based on voltage and resistance characteristics.

In some embodiments, a receiving module 208 can comprise a storage receptacle configured to store a received battery, and features configured to place a received battery in the storage receptacle. In some embodiments, the storage receptacle can include features configured to monitor the status of the storage receptacle and to provide status information to the controller. The two-way battery vending machine, upon receiving a rechargeable or proprietary battery, may provide the battery to an internal charging system. In some embodiments, the internal charging system may have limited capacity. If the internal charging system cannot accommodate a received battery, the two-way vending machine may store the battery in a storage receptacle to await further charging.

In some embodiments, a two-way rechargeable battery vending machine 200 can comprise a network communications module. The network communications module can be configured to communicate with another entity on a network. In some embodiments, the network communications module can be configured to communicate with a server across a network, such as, for example, across the internet, and can include features configured for wired or wireless communication.

The network communications module can be configured, in some embodiments, to transmit information to the server relating to the identification of a user, to the purchase by the user, to user payment details, and any other desired information. In some embodiments in which the user identifies himself to the two-way rechargeable battery vending machine 200, the network communications module can transmit this identification information to the server. The server can determine which, if any, account is associated with the user, and provide account information to the two-way rechargeable battery vending machine 200. In some embodiments in which the user makes a payment to the two-way rechargeable battery vending machine 200, the two-way rechargeable battery vending machine 200 can provide information relating to the payment to the server. This information can include, for example, the amount of payment, whether a credit should be associated with the user account, payment account information such as, for example, a credit card or bank card number or identifier, or any other payment information. The server can then associate this payment information with the user account.

In some embodiments, the two-way rechargeable battery vending machine 200 can provide information relating to the purchase of the user, such as, for example, the number and type of items purchased, the number and/or type of items returned, or any other desired information. This information can be associated with the user account, and in some embodiments in which an item is returned, may be associated with the user account in the form of a credit or a tentative credit to the account.

In some embodiments, the network communications module can communicate information to the server relating to the status of the two-way rechargeable battery vending machine 200. Thus, in some embodiments, the network communications module can send a signal to the server when the two-way rechargeable battery vending machine 200 requires servicing such as, for example, replenishing of the stock of charged batteries, battery power units, or other vended items, removal of deposited discharged batteries or other used items, or any other required service. A person of skill in the art will recognize that the network communications module can communicate a variety of other information with the server, and that the present disclosure is not limited to the above-described specific embodiments.

In some embodiments, where the internal charging system lacks sufficient capacity to charge received batteries, the network communications module may communicate the lack of charging capacity to the server. The network communications module may communicate charging capacity information with other two-way rechargeable battery vending machines or with a central battery charging hub.

### Method of Operation of a Two-Way Rechargeable Battery Vending Machine

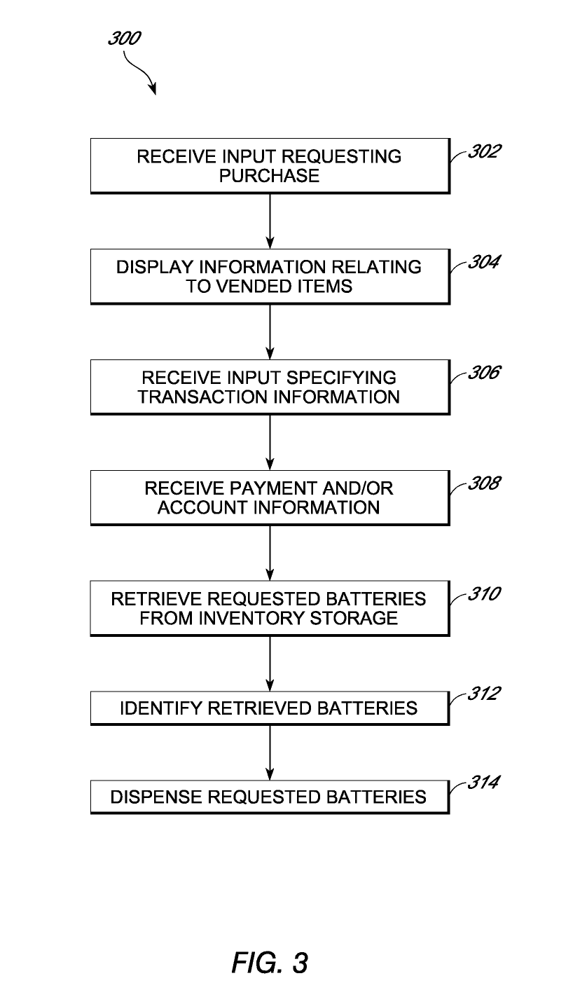

The features of a two-way rechargeable battery vending machine can be controlled to achieve the desired vending and/or receipt of one or several batteries. FIGS. 3 to 5 depict different methods of operating different aspects of a two-way rechargeable battery vending machine, focusing on the method of distributing an item and/or on the method of receiving an item and/or a rechargeable battery.

FIG. 3 depicts one embodiment of a method 300 of operating a two-way rechargeable battery vending machine to distribute one or several rechargeable batteries. In some embodiments, the method 300 begins when an input requesting purchase of one or several rechargeable batteries is received at block 302. This request can be received, as discussed above via a communications module.

Having received an input requesting purchase of an item, the controller can request communication of information relating to the one or several rechargeable batteries via the communications module, as depicted in block 304. This information can include, among other things, price information of the one or several rechargeable batteries, availability of the one or several rechargeable batteries, instructions for proceeding with the transaction, instructions for termination of the transaction, or any other desired information.

In some embodiments of a method 300 of operating a two-way rechargeable battery vending machine to distribute one or several rechargeable batteries, a communications module can include receiving an input specifying transaction information as depicted in block 306. This information can include, for example, the type of rechargeable batteries requested for purchase, the number of rechargeable batteries requested for purchase, and/or any other information.

In some embodiments of a method 300 of operating a two-way rechargeable battery vending machine to distribute one or several rechargeable batteries can include receiving payment and/or account information as depicted in block 308. In some embodiments, payment can be achieved by insertion of money into payment module, by communicating information from a credit card or other form of electronic payment to the payment module, such as, by, for example, swiping a credit card through a magnetic strip reader, moving a credit card with an RFID tag near a detector, scanning a two-dimensional or three-dimensional code, inputting a unique identifier, such as a card, wirelessly transmitting payment information from a mobile electronic device, such as a tablet computer or a smart phone, or by other method of transferring payment. In some embodiments, account information can be received via input of an account number, email address, or other account identifier into the communications module.

A method 300 of operating a two-way rechargeable battery vending machine to distribute one or several rechargeable batteries can include retrieving the requested items from an inventory storage as depicted in block 310. A method 300 of operating a two-way rechargeable battery vending machine to distribute one or several rechargeable batteries can further include identifying the one or more rechargeable batteries retrieved from the inventory storage as depicted in block 312. In some embodiments, identifying the one or more rechargeable batteries retrieved from the inventory storage can include, for example, retrieving information from an identification feature located on one or more of the requested batteries, or on one or more battery cases containing the one or more requested batteries. As discussed above, the identification feature can include, for example, a computer readable code, a visible feature, transmitted data, or any other feature capable of uniquely or non-uniquely identifying the one or more batteries.

A method 300 of operating a two-way rechargeable battery vending machine to distribute one or several rechargeable batteries can, in some embodiments, include dispensing of the requested one or more rechargeable batteries as depicted in block 314.

A person of skill in the art will recognize that a method 300 of operating a two-way rechargeable battery vending machine to distribute one or several rechargeable batteries can include some or all of the above discussed steps, as well as steps additional to the above requested steps. A person of skill in the art will further recognize that a method 300 of operating a two-way rechargeable battery vending machine to distribute one or several rechargeable batteries can include the above listed steps performed in any order, including in an order different than that shown above.

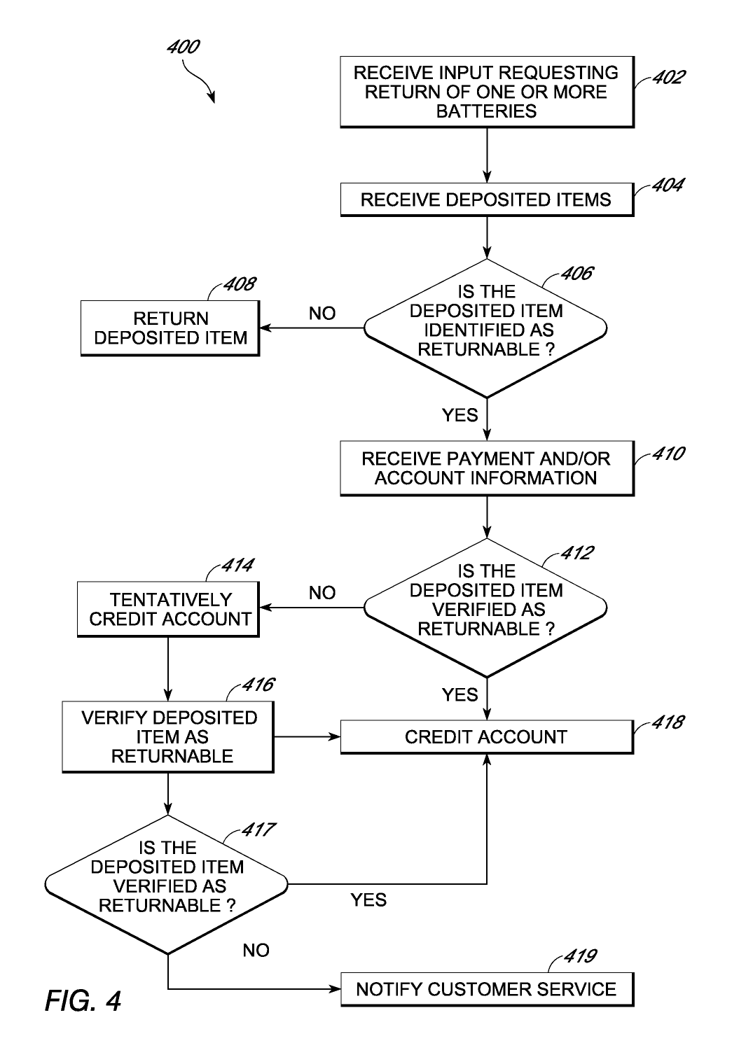

FIG. 4 depicts one embodiment of a method 400 of operating a two-way rechargeable battery vending machine to receive one or several deposited rechargeable batteries. In some embodiments, the method 400 begins when an input is received requesting the return of one or more batteries as depicted in block 402. In some embodiments, this input can be received, as discussed above, via a communications module.

In some embodiments of a method 400 of operating a two-way rechargeable battery vending machine to receive one or several deposited rechargeable batteries, one or several batteries can be received as depicted in block 404. In some embodiments, the one or several deposited rechargeable batteries can be received in a receiving receptacle.

After receiving the one or several batteries in a receiving receptacle, method 400 can move to decision block 406 and determine if the deposited item is identified as returnable. Identification of the received batteries can be advantageous in preventing the crediting of an account for the return of batteries other than a desired type. In some embodiments, this can include the prevention of crediting an account for the return of disposable batteries, of a non-battery item, of rechargeable batteries of a non-desired brand, or any other undesired item. In some embodiments, identification can be performed by use of an identification feature on the one or several batteries, or on one or several battery cases holding the one or several batteries.

In some embodiments of a method 400 of operating a two-way rechargeable battery vending machine to receive one or several deposited rechargeable batteries, if the received item is not identified as returnable, the received item can be returned as depicted in block 408, or disposed of.

If the received item is identified as a returnable battery, method 400 can move to block 410 and receive payment and/or account information associated with the user returning the one or several batteries.

Method 400 of operating a two-way rechargeable battery vending machine to receive one or several deposited rechargeable batteries can move to decision state 412 and determine if the deposited item is verified as returnable. In some embodiments, the use of an identification feature may not be sufficient to determine if a received item or battery is returnable. For example, in some embodiments, an identification feature located on a battery case may sufficiently identify the received items to allow the return transaction to advance, but may not be sufficient to allow completion of the return transaction as the identification feature identifies a battery case and not the battery contained in the battery case. In this embodiment, reading of the identification feature found on the battery case indicates that the deposited item is likely of the right type, but may not determine that the deposited item is returnable. Similarly, in some embodiments, one or several received batteries may be damaged or otherwise rendered inoperable. Thus, in some embodiments, a deposited item is verified as returnable by, for example, identifying each of the one or several received batteries as returnable, and/or verifying that each of the one or several received batteries meets return criteria. In some embodiments, this verification can include, for example, image analysis, functional analysis, or any other desired analysis. In some embodiments, image analysis can comprise analyzing an image of the one or several received batteries for identification and functionality criteria such as, for example, battery packaging, or visible signs of damage to the battery. In some embodiments, functional analysis can include, for example, testing the one or several batteries' performance characteristics, such as charging and discharging characteristics, which can include, for example, a measurement of battery voltage and/or internal impedance/resistance.

In some embodiments of a method 400 of operating a two-way rechargeable battery vending machine to receive one or several deposited rechargeable batteries, failure to verify the deposited one or several batteries as returnable can result in providing a preliminary indication of an account credit. In some embodiments, failure to verify the deposited one or several items and/or one or several batteries as returnable can result in postponed crediting of an account as depicted in block 414 until the batteries are verified as returnable. In some embodiments, the deposited one or several batteries can be verified as returnable as depicted in block 416. This verification can, in some embodiments, be performed as discussed above. In some embodiments, this verification can be automatically performed. In some embodiments, this verification can be performed by a human.

Method 400 of operating a two-way rechargeable battery vending machine to receive one or several deposited rechargeable batteries can move to decision state 417 and determine if the deposited item is verified as returnable. If the verification process of block 416 was unsuccessful, and the deposited item is not verified as returnable, customer service can be notified as depicted in block 419. In some embodiments, customer service can use then request the returned items to perform a manual inspection, and/or can add information to the customer account relating to the inability of the system to verify the deposited item as returnable.

If the deposited item is verified as returnable, as depicted in decision state 417, or after determining that the deposited item is verified as returnable as depicted in decision state 412, the account can be credited as depicted in block 418. In some embodiments, crediting of an account can include dispensing cash payment to a user, transferring money to credit or debit card, which can be, for example, the card used for purchase, or swiped at the time of return, or any other form of providing a credit to a user and/or the associated account.

A person of skill in the art will recognize that a method 400 of operating a two-way rechargeable battery vending machine to receive one or several rechargeable batteries can include some or all of the above discussed steps, as well as steps additional to the above requested steps. A person of skill in the art will further recognize that a method 400 of operating a two-way rechargeable battery vending machine to receive one or several rechargeable batteries can include the above listed steps performed in a different order than shown above.

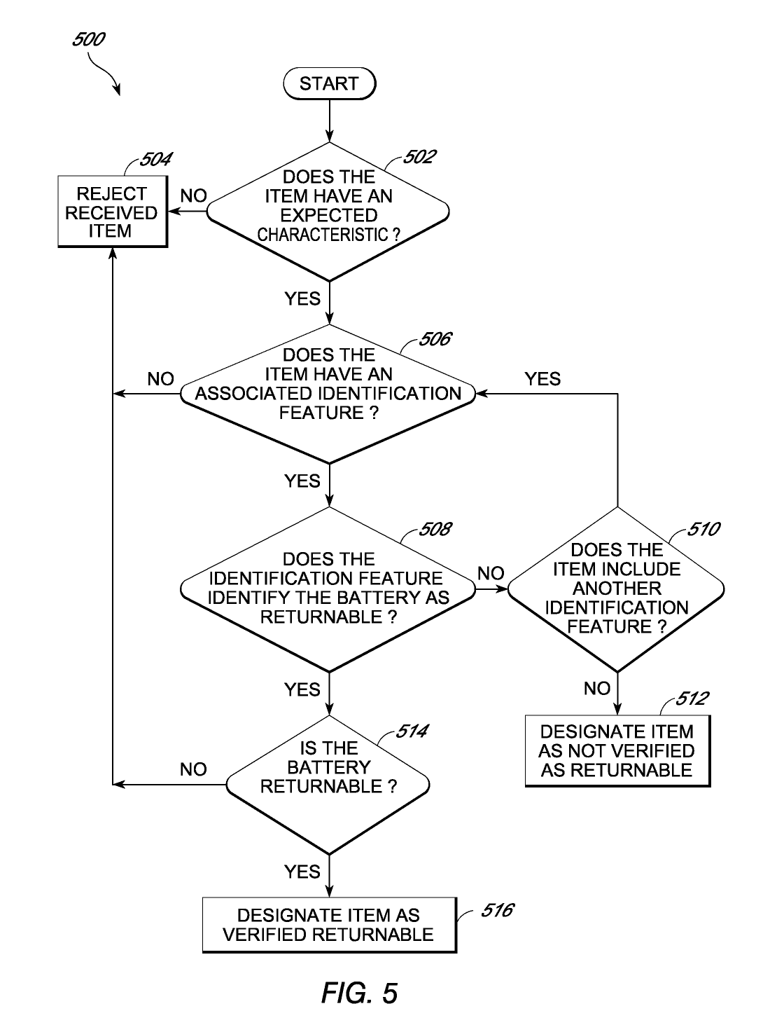

FIG. 5 depicts one embodiment of a method 500 of operating a two-way rechargeable battery vending machine to determine if one or several received items are returnable, rechargeable batteries. In some embodiments, the method 500 moves to decision state 502 to determine if one or several received items have an expected characteristic. In some embodiments, this characteristic can include a physical characteristic such as, for example, a weight, a size, and a color or color scheme. In some embodiments, this characteristic can be identified by one or more sensors. In some embodiments, in which the characteristic is the weight, the weight can be determined by a scale. In some embodiments, the measured weight can be compared, for example, to an expected weight or an expected weight range for one or several batteries.

In some embodiments, if the item does not have a weight matching an expected weight, or falling within an expected weight range, a received item is rejected, as depicted in block 504.

If the item does have a weight matching an expected weight, or falling within an expected weight range, the process 500 moves to decision state 506 and determines if the received item has an associated identification feature. If the received item does not have an associated identification feature, the received item is rejected as depicted in block 504.

If the item is determined as having an associated identification feature, the method 500 moves to decision state 508 to determine if the identification feature identifies a returnable rechargeable battery. As discussed above, in some embodiments, one or several batteries may be received in one or several battery cases. In such embodiments, an identification feature may be located on the one or several battery cases, and may identify the case and not a returnable rechargeable battery. In other embodiments, an identification feature may be located on the one or several batteries, and may identify the one or several returnable rechargeable batteries.

If the item does not have an identification feature that identifies a returnable rechargeable battery, the method 500 optimally moves to decision state 510 to determine if the item includes an additional identification feature. If the item does not include an additional identification feature, then the item is designated as not verified returnable as depicted in block 512, and decision state 417 depicted in FIG. 4 would lead to notifying customer service as depicted in block 419 of FIG. 4. If the item does include an additional identification feature, then the process 500 returns to decision state 506 to analyze the additional identification feature.

If a determination is made in decision state 508 that the identification feature identifies a returnable rechargeable battery, process 500 moves to decision state 514 to determine if the battery is returnable. This determination can include, for example, functional testing of the battery, evaluation of the exterior condition of the battery, or any other desired testing. If the battery is not returnable, the received item is rejected as depicted at block 504. If the battery is returnable, then the received battery is designated as verified returnable as depicted in block 516, and decision state 417 depicted in FIG. 4 would lead to crediting the account as depicted in block 418 of FIG. 4.

A person of skill in the art will recognize that a method 500 of operating a two-way rechargeable battery vending machine to determine if one or several deposited rechargeable batteries are returnable can include some or all of the above discussed steps, as well as steps additional to the above requested steps. A person of skill in the art will further recognize that a method 500 of operating a two-way rechargeable battery vending machine to distribute one or several rechargeable batteries can include the above listed steps performed in a different order than that shown above.

The technology is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be a microcontroller or any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and may be run under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a microcontroller, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A two-way battery vending machine comprising:
a communications module configured to communicate information to a user and to receive inputs from a user including input indicia of the user identity;
a dispenser configured to dispense a selected battery;
a receiver configured to receive a battery;
an identifier configured to identify a battery by reference to an identification characteristic;
a processor configured to control the vending machine; and,
memory comprising stored instructions for operation of the vending machine.

2. The two-way battery vending machine of claim 1, further comprising a receptacle to store a received battery.

3. The two-way battery vending machine of claim 1, further comprising a storage area for the battery before it is dispensed.

4. The two-way battery vending machine of claim 1, further comprising a network communications module configured to communicate vending machine information across a network.

5. The two-way battery vending machine of claim 1, wherein the two-way battery vending machine is configured to associate the battery with a user account.

6. The two-way battery vending machine of claim 5, wherein associating the battery with an account further comprises associating the identification characteristic with a user account.

7. The two-way battery vending machine of claim 1, wherein the identifier comprises a scale and wherein the unique identification characteristic comprises a weight.

8. The two-way battery vending machine of claim 1, wherein the identifier comprises a scanner and the identification characteristic comprises a computer readable code.

9. The two-way battery vending machine of claim 1, wherein the identifier comprises a camera and the identification characteristic comprises a visible feature.

10. The two-way battery vending machine of claim 1 wherein the identification characteristic comprises a pattern.

11. The two-way battery vending machine of claim 1, wherein the identification characteristic comprises one or more colors.

12. The two-way battery vending machine of claim 1, wherein the identification characteristic comprises an ultraviolet marking.

13. The two-way battery vending machine of claim 1, wherein the identification characteristic comprises a fluorescent marking.

14. The two-way battery vending machine of claim 1, wherein the identification characteristic comprises an infra-red marking.

15. The two-way battery vending machine of claim 1, wherein the identification characteristic comprises a radio emitter.

16. The two-way battery vending machine of claim 5 wherein the network communication module is configured to communicate with a server across a network.

17. A method of using the two-way battery vending machine of claim 1, the method comprising:
dispensing a requested battery, wherein said dispensing comprises:
receiving a request for dispensing of a battery via the communications module;
processing the request with the processor;
identifying the requested battery by said identification characteristic;
associating the requested battery with an account; and,
dispensing the requested battery; and,
receiving a battery, wherein said receiving comprises:
identifying the received battery;
associating the received battery with an account; and
crediting the account when the received battery has specified characteristics.

18. The method of claim 17, wherein the requested battery is dispensed in a battery container.

19. The method of claim 18, wherein the requested battery container includes an identification feature.

20. The method of claim 17, wherein indentifying the requested battery comprises scanning a computer readable code.

21. The method of claim 17, wherein identifying the requested battery comprises receiving a data containing radio signal.

22. The method of claim 17, wherein associating the requested battery with an account comprises associating the identification characteristic with an electronic payment account.

23. The method of claim 22, wherein the electronic payment account comprises a credit account.

24. The method of claim 22, wherein the electronic payment account comprises a bank account.

25. The method of claim 17, wherein associating the requested battery with an account comprises associating the unique identification characteristic with a user account identifier.

26. The method of claim 25, wherein the user account identifier comprises an email account.

27. The method of claim 25, wherein the user account identifier comprises an account number.

28. The method of claim 25, wherein the user account identifier comprises a user name.
